(19) United States
(12) Patent Application Publication
(10) Pub. No.: US 2026/0126067 A1
(43) Pub. Date: May 7, 2026

(54) COMPENSATION NUT FASTENING ASSEMBLY AND TORQUE CLIP THEREOF

(71) Applicant: ILLINOIS TOOL WORKS INC., Glenview, IL (US)

(72) Inventor: Weibin LIU, Shanghai (CN)

(21) Appl. No.: 19/380,406

(22) Filed: Nov. 5, 2025

(30) Foreign Application Priority Data
Nov. 4, 2024 (CN) 2024115622237

(51) Int. Cl. F16B 5/02; F16B 37/04

(52) U.S. Cl. CPC F16B 5/025; F16B 37/043

(57) ABSTRACT

The present disclosure provides a compensation nut fastening assembly including a first nut, a second nut receiving the first nut, and a torque clip received in the first nut. The torque clip has a substantially triangular cross section and includes a first retaining wall, a second retaining wall and a third retaining wall. The second retaining wall is connected to the first retaining wall by a first connecting wall which forms a pair of first bent protrusions with the first and second retaining walls. The third retaining wall is connected to the second retaining wall by a second connecting wall which forms a pair of second bent protrusions with the second and third retaining walls, and is separated from the first retaining wall. The first and third retaining walls form a first free end and a second free end. The first, second and third retaining walls form a fastener passage and are configured to be in contact with a fastener inserted into the fastener passage to retain the fastener. The first and send bent protrusions and the first and second free ends are configured to be in contact with the first nut to retain the torque clip.

### RELATED APPLICATIONS

The present application claims the benefit of Chinese Patent Application No. 2024115622237, filed Nov. 4, 2024, titled “Compensation Nut Fastening Assembly And Torque Clip Thereof,” the contents of which are hereby incorporated by reference.

### TECHNICAL FIELD

The present disclosure relates generally to a fastening assembly, and in particular to a compensation nut fastening assembly configured to compensate for a gap between components (e.g., panels) and a torque clip thereof.

### BACKGROUND

In various industrial applications, components are connected together by using fasteners. In some applications, there may be a gap between components. For example, two panels may be separated by a clearance zone or a gap, and portions of other components may be remained in the clearance zone or the gap. A fastener assembly may rattle or slide within the gap when the panels are connected together, thereby generating unwanted noise and creating a loose connection, or causing the panels to be deformed by the locking force.

Some fastening assemblies employ at least two intermeshing nuts and employ a torque clip. The torque clip is inserted into the innermost nut and configured to retain a fastener (e.g., a bolt or a screw) when the fastener is inserted into the nut and cause the nut to rotate as the fastener rotates, so as to adjust the height of these nuts to fill the gap between the panels.

### SUMMARY OF THE DISCLOSURE

The present disclosure generally relates to a compensation nut fastening assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 is a perspective view of a compensation nut fastening assembly according to an embodiment of the present disclosure in an initial position when securing two components.

FIG. 2A is a perspective view of the compensation nut fastening assembly shown in FIG. 1.

FIG. 2B is an exploded view of the compensation nut fastening assembly shown in FIG. 2A.

FIG. 3A is a perspective view of a torque clip of the compensation nut fastening assembly shown in FIGS. 2A and 2B.

FIG. 3B is a top view of the torque clip of the compensation nut fastening assembly shown in FIGS. 2A and 2B that receives a fastener.

FIG. 4 is a top view of the compensation nut fastening assembly shown in FIG. 2A.

FIG. 5A is a perspective view of the compensation nut fastening assembly shown in FIGS. 2A and 2B during the process of securing the two components.

FIG. 5B is a perspective view of the compensation nut fastening assembly shown in FIGS. 2A and 2B that secures the two components in place.

### DETAILED DESCRIPTION OF EMBODIMENTS

References to items in the singular should be understood to include items in the plural, and vice versa, unless explicitly stated otherwise or clear from the text.

Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or. ” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides a compensation nut fastening assembly which includes a first nut, a second nut and a torque clip. The first nut defines a first passage through an inner wall thereof. The second nut receives the first nut. The torque clip is received in the first passage of the first nut. The torque clip has a substantially triangular cross section and includes a first retaining wall, a second retaining wall and a third retaining wall. The second retaining wall is connected to the first retaining wall by a first connecting wall, and the first connecting wall forms a pair of first bent protrusions with the first retaining wall and the second retaining wall. The third retaining wall is connected to the second retaining wall by a second connecting wall and separated from the first retaining wall, and the second connecting wall forms a pair of second bent protrusions with the second retaining wall and the third retaining wall. The first retaining wall and the third retaining wall form a first free end and a second free end, respectively. The first retaining wall, the second retaining wall and the third retaining wall jointly form a fastener passage and are configured to be in contact with a fastener inserted into the fastener passage, so as to retain the fastener in the fastener passage. The pair of first bent protrusions, the pair of second bent protrusions, the first free end and the second free end are configured to be in contact with the inner wall of the first nut, so as to retain the torque clip in the first passage of the first nut.

In some embodiments, a gap is provided between either of the first connecting wall and the second connecting wall and the fastener received in the fastener passage.

In some embodiments, a ratio of a length of either of the first connecting wall and the second connecting wall to a length of either of the first retaining wall and the third retaining wall is in a range from 10% to 50%.

In some embodiments, the first retaining wall, the second retaining wall and the third retaining wall are straight walls.

In some embodiments, the first retaining wall, the second retaining wall and the third retaining wall are provided with guide flared openings on top portions thereof.

In some embodiments, the torque clip is provided with hollowed portions penetrating through the torque clip in a thickness direction of the torque clip.

In some embodiments, the hollowed portions include a first hollowed portion and a second hollowed portion. The first hollowed portion extends from the first connecting wall into the first retaining wall and the second retaining wall, and the second hollowed portion extends from the second connecting wall into the second retaining wall and the third retaining wall.

In some embodiments, the torque clip is integrally made of metal.

According to a second aspect of the present disclosure, the present disclosure provides a torque clip for a compensation nut fastening assembly. The torque clip includes a first retaining wall, a second retaining wall and a third retaining wall. The second retaining wall is connected to the first retaining wall by a first connecting wall, and the first connecting wall forms a pair of first bent protrusions with the first retaining wall and the second retaining wall. The third retaining wall is connected to the second retaining wall by a second connecting wall and separated from the first retaining wall. The second connecting wall forms a pair of second bent protrusions with the second retaining wall and the third retaining wall, and the first retaining wall and the third retaining wall form a first free end and a second free end, respectively. The first retaining wall, the second retaining wall, and the third retaining wall jointly form a fastener passage. The torque clip has a substantially triangular cross section.

In some embodiments, a ratio of a length of either of the first connecting wall and the second connecting wall to a length of either of the first retaining wall and the third retaining wall is in a range from 10% to 50%.

In some embodiments, the first retaining wall, the second retaining wall and the third retaining wall are straight walls.

In some embodiments, the first retaining wall, the second retaining wall and the third retaining wall are provided with guide flared openings on top portions thereof.

In some embodiments, the torque clip is provided with hollowed portions penetrating through the torque clip in a thickness direction of the torque clip.

In some embodiments, the hollowed portions include a first hollowed portion and a second hollowed portion, the first hollowed portion extends from the first connecting wall into the first retaining wall and the second retaining wall, and the second hollowed portion extends from the second connecting wall into the second retaining wall and the third retaining wall.

In some embodiments, the torque clip is integrally made of metal.

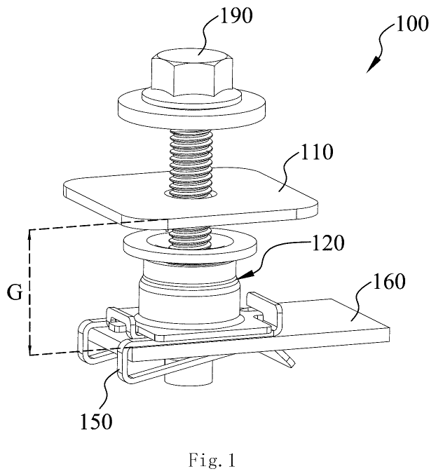

FIG. 1 is a perspective view of a compensation nut fastening assembly 120 according to an embodiment of the present disclosure in an initial position when securing two components. As shown in FIG. 1, the compensation nut fastening assembly 120 is used with a fastener 190 to secure a first component 110 and a second component 160. The first component 110 and the second component 160 are exemplarily shown in FIG. 1 as plate-like components with a gap G between them. The compensation nut fastening assembly 120 is connected to the second component 160 via a clip 150, and the height of the compensation nut fastening assembly 120 in its axial direction is adjustable. In this way, when the height of the compensation nut assembly 120 is adjusted to match the gap G between the first component 110 and the second component 160, the compensation nut fastening assembly 120 can a but against the first component 110, so that the gap G between the first component 110 and the second com ponent 160 can be maintained while fastening the first component 110 and the second component 160. In addition, due to its adjustable height, the compensation nut fastening assembly 120 is adaptable for securing the first component 110 and the second component 160 with different gaps G.

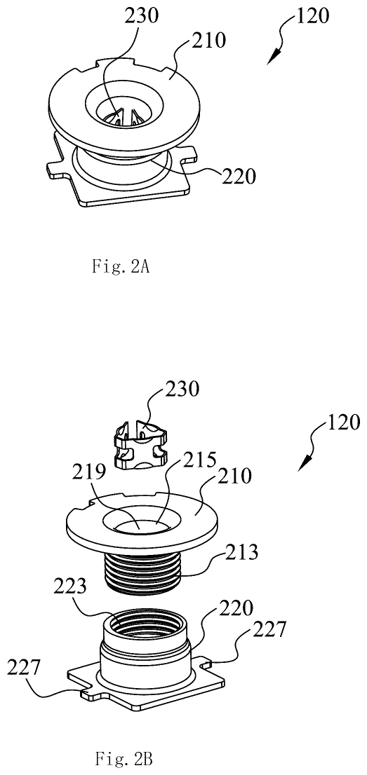

FIGS. 2A and 2B show the overall structure of the compensation nut fastening assembly 120. FIG. 2A is a perspective view of the compensation nut fastening assembly 120, and FIG. 2B is an exploded view of the compensation nut fastening assembly 120. As shown in FIG. 2A, the compensation nut fastening assembly 120 includes two nuts, namely a first nut 210 and a second nut 220, which are threadedly connected to each other, and a torque clip 230.

As shown in FIG. 2B, the first nut 210 defines a first passage 219 through an inner wall 215 thereof, and includes an external thread 213 provided on an outer wall thereof. The second nut 220 includes an internal thread 223 provided on an inner wall thereof. The second nut 220 receives the first nut 210, and the second nut 220 is in threaded connection with the first nut 210 by means of cooperation between the internal thread 223 and the external thread 213. The torque clip 230 is received in the first passage 219 of the first nut 210 for retaining the fastener 190 shown in FIG. 1 in the first nut 210, enabling the fastener 190 to drive the first nut 210 to rotate relative to the second nut 220 by means of the torque clip 230. Since the first nut 210 and the second nut 220 can rotate relative to each other, the first nut 210 can move along an axis relative to the second nut 220, so as to adjust the height of the compensation nut assembly 120. In this way, by adjusting the height of the compensation nut assembly 120, the compensation nut fastening assembly 120 is adaptable for securing the first component 110 and the second component 160 with different gaps G.

A lower end of the second nut 220 is further provided with a pair of connecting tabs 227 disposed on two opposite sides of the second nut 220 for cooperating with the clip 150 in FIG. 1 to connect the compensation nut fastening assembly 120 to the second component 160.

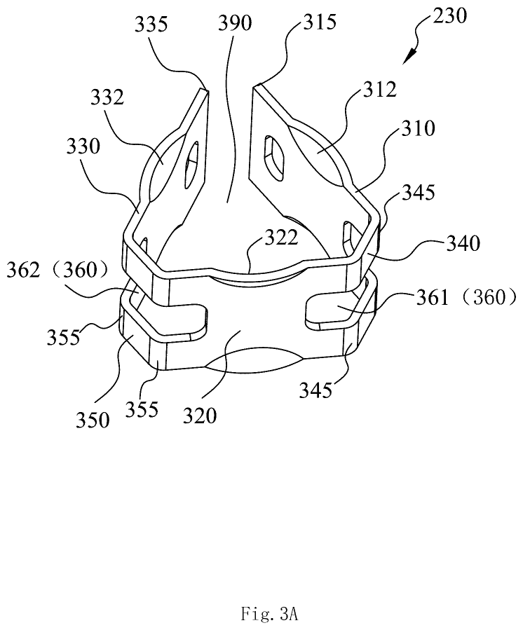

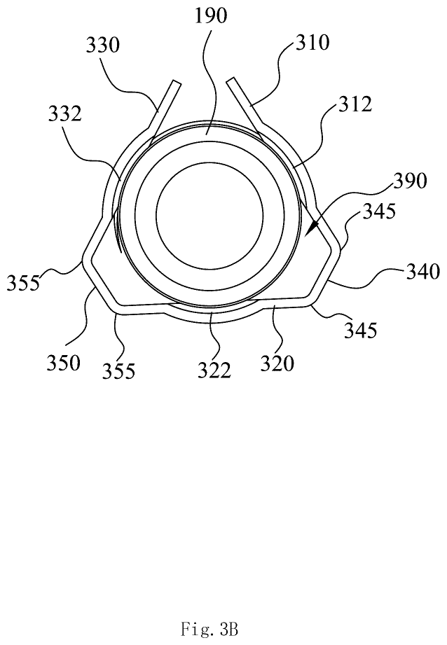

FIG. 3A is a perspective view of the torque clip 230 of the compensation nut fastening assembly 120 shown in FIG. 2A, showing a specific structure of the torque clip 230. In some embodiments, the torque clip 230 is integrally made of metal. For example, the torque clip 230 is formed from a metal sheet using a process of bending, stamping, etc.

As shown in FIG. 3A, the torque clip 230 includes a first retaining wall 310, a second retaining wall 320, and a third retaining wall 330. The second retaining wall 320 is connected to the first retaining wall 310 by a first connecting wall 340, and the third retaining wall 330 is connected to the second retaining wall 320 by a second connecting wall 350. The first retaining wall 310 is separate from the third retaining wall 330, so that the first retaining wall 310 and the third retaining wall 330 form a first free end 315 and a second free end 335, respectively. The first connecting wall 340 forms a first bent protrusion 345 with each of the first retaining wall 310 and the second retaining wall 320, so that a total of one pair of first bent protrusions 345 are formed. The second connecting wall 350 forms a second bent protrusion 355 with each of the second retaining wall 320 and the third retaining wall 330, so that a total of one pair of second bent protrusions 355 are formed. The first retaining wall 310, the second retaining wall 320, and the third retaining wall 330 jointly form a fastener passage 390 for receiving the fastener 190.

In this way, the torque clip 230 is shaped to have a substantially triangular cross section having two closed ends and an open end. The three retaining walls (the first retaining wall 310, the second retaining wall 320 and the third retaining wall 330) form three sides of the triangle, the two connecting walls (the first connecting wall 340 and the second connecting wall 350) form the two closed ends of the triangle, and the open end is formed by the first free end 315 and the second free end 335 which are separated from each other.

In some embodiments, the torque clip 230 forms a substantially symmetrical shape with respect to the fastener passage 390, the two connecting walls (the first connecting wall 340 and the second connecting wall 350) have substantially the same dimensions, and two of the retaining walls (the first retaining wall 310 and the third retaining wall 330) have substantially the same dimensions. In some embodiments, the two connecting walls and the three retaining walls have substantially the same width in the axial direction of the fastening assembly, and have substantially the same thickness.

In some embodiments, the length of each of the two connecting walls is much less than each of the length of the two retaining walls (the first retaining wall 310 and the third retaining wall 330), approximately 10% to 50% of each of the length of the two retaining walls (the first retaining wall 310 and the third retaining wall 330).

As still shown in FIG. 3A, the first retaining wall 310, the second retaining wall 320 and the third retaining wall 330 are straight walls with guide flared openings 312, 322, 332 respectively on top portions thereof. The guide flared openings 312, 322, 332 are formed by arcuately expanding the top portions of the three retaining walls outward, for guiding the insertion of the fastener 190 into the torque clip 230.

In addition, the torque clip 230 is provided with hollowed portions 360 penetrating through the torque clip 230 in a thickness direction of the torque clip 230. The hollowed portions include a first hollowed portion 361 and a second hollowed portion 362. The first hollowed portion 361 extends from the first connecting wall 340 into the first retaining wall 310 and the second retaining wall 320, and the second hollowed portion 362 extends from the second connecting wall 350 into the second retaining wall 320 and the third retaining wall 330. The provision of the hollowed portions can increase the elasticity of the torque clip 230.

FIG. 3B is a top view of the torque clip 230 receiving the fastener 190. As shown in FIG. 3B, when the fastener 190 is received in the fastener passage 390 of the torque clip 230, the fastener 190 is in contact with the three retaining walls (the first retaining wall 310, the second retaining wall 320 and the third retaining wall 330). However, the fastener 190 is not in contact with the two connecting walls (the first connecting wall 340 and the second connecting wall 350), but has a gap therewith. That is, the three retaining walls, rather than the two connecting walls, retain the fastener 190 in the fastener passage 390. In a free state of the torque clip 230, the radial dimension of the fastener passage 390 of the torque clip 230 is smaller than the radial dimension of the fastener 190 such that the fastener 190 exerts an outward thrust force on the first retaining wall 310 and the third retaining wall 330, causing the first retaining wall 310, the second retaining wall 320 and the third retaining wall 330 to clamp the fastener 190 with a certain elastic force.

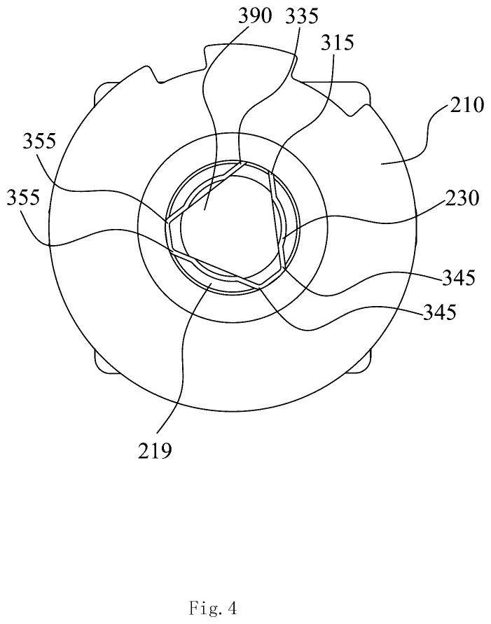

FIG. 4 is a top view of the compensation nut fastening assembly 100 shown in FIG. 2A, showing the positional relationship between the torque clip 230 and the first nut 210. As shown in FIG. 4, the torque clip 230 is received in the first passage 219 of the first nut 210, and the fastener passage 390 defined by the torque clip 230 is substantially coaxial with the first passage 219 defined by the inner wall 215 of the first nut 210. The pair of first bent protrusions 345, the pair of second bent protrusions 355, and the two free ends (the first free end 315 and the second free end 335) of the torque clip 230 are in contact with the inner wall 215 of the first nut 210, so as to retain the torque clip 230 in the first passage 219 of the first nut 210.

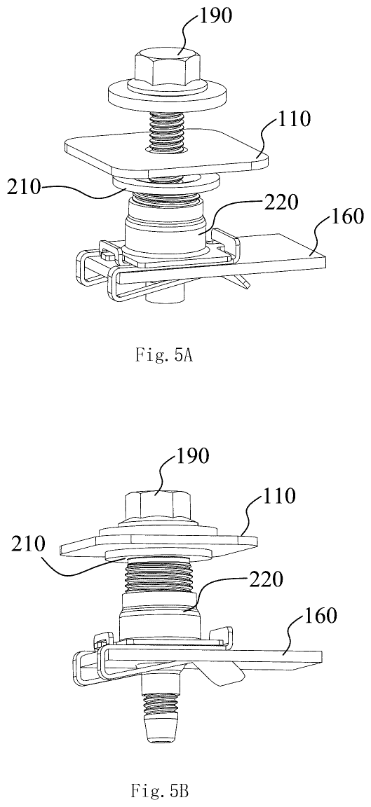

FIGS. 5A and 5B show the process of securing the first component and the second component by the compensation nut fastening assembly 100. FIG. 5A is a perspective view of the compensation nut fastening assembly 100 during the process of securing the two components, and FIG. 5B is a perspective view of the compensation nut fastening assembly 100 that secures the two components in place.

As shown in FIG. 5A, the first nut 210 moves upwardly relative to the second nut 220, closer to the first component 110 than in the initial state shown in FIG. 1, but has not yet touched the first component 110.

As shown in FIG. 5B, the first nut 210 moves further upwardly relative to the second nut 220 compared to the state shown in FIG. 5A, and touches the first component 110.

During the process from FIG. 1 to FIG. 5A and then to FIG. 5B, the axial movement of the first nut 210 relative to the second nut 220 is actuated by rotation of the fastener 190 because the torque clip 230 clamps the fastener 190 and is retained in the first passage 219 of the first nut 210, and the rotation of the fastener 190 then causes the first nut 210 to rotate relative to the second nut 220 by means of the torque clip 230. That is, the torque applied to the fastener 190 can be transmitted to the first nut 210 through the torque clip 230. In this way, by tightening the fastener 190, the height of the compensation nut fastening assembly 100 can be adjusted to compensate for the gap G between the first component 110 and the second component 160.

In the present disclosure, by providing the torque clip with two connecting walls connected to adjacent retaining walls but not in contact with the fastener, the friction between the torque clip and the inner wall of the first nut can be increased without increasing the requirements of manufacturing precision of the torque clip.

In particular, by providing the connecting walls, the connecting walls configured as connecting corners between the adjacent retaining walls can form a plurality of bent protrusions which come into contact with the inner wall of the first nut that receives the torque clip, and the friction between the torque clip and the inner wall of the first nut can be increased, so that the torque clip can be retained in the first nut better, thereby preventing the torque clip from being separated from the first nut, and making it easier for the fastener to rotate the first nut by means of the torque clip. In addition, the two connecting walls of the present disclosure are not in contact with the fastener, but are spaced apart from the fastener, with a gap therebetween. Therefore, the provision of the connecting walls in the present disclosure does not increase the number of structures in contact with the fastener, and thus does not increase the requirements of manufacturing precision of the torque clip, because too many walls in contact with the fastener result in increased requirements for manufacturing precision of the torque clip, making the torque clip difficult to manufacture. For example, when the torque clip has five walls in contact with the fastener at the same time, the positional relationship of the five walls with respect to each other, if not precisely set, may result in that they are not in contact with the fastener and thus fail to clamp the fastener, or that the clamping force is too large and the fastener is not easy to be inserted into the torque clip.

Furthermore, in the present disclosure, the retaining walls of the torque clip for maintaining contact with the fastener are substantially straight walls, rather than curved walls, so that it is also possible to reduce the requirements for manufacturing tolerances of the torque clip. When the requirements for manufacturing tolerances are low, the torque clip is relatively easy to achieve manufacturing precision.

In addition, the top portion of each retaining wall of the torque clip in the present disclosure is designed with a flared structure, making it easier to insert the fastener into the torque clip.

Although the present disclosure is described with reference to the examples of the embodiments, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

1. A compensation nut fastening assembly, comprising:
a first nut defining a first passage through an inner wall thereof;
a second nut receiving the first nut; and
a torque clip received in the first passage of the first nut, the torque clip having a substantially triangular cross section and comprising:
a first retaining wall;
a second retaining wall connected to the first retaining wall by a first connecting wall, the first connecting wall forming a pair of first bent protrusions with the first retaining wall and the second retaining wall; and
a third retaining wall connected to the second retaining wall by a second connecting wall and separated from the first retaining wall, the second connecting wall forming a pair of second bent protrusions with the second retaining wall and the third retaining wall, and the first retaining wall and the third retaining wall forming a first free end and a second free end, respectively,
wherein the first retaining wall, the second retaining wall and the third retaining wall jointly form a fastener passage and are configured to be in contact with a fastener inserted into the fastener passage, so as to retain the fastener in the fastener passage, and
wherein the pair of first bent protrusions, the pair of second bent protrusions, the first free end and the second free end are configured to be in contact with the inner wall of the first nut, so as to retain the torque clip in the first passage of the first nut.

2. The compensation nut fastening assembly according to claim 1, wherein a gap is provided between either of the first connecting wall and the second connecting wall and the fastener received in the fastener passage.

3. The compensation nut fastening assembly according to claim 2, wherein a ratio of a length of either of the first connecting wall and the second connecting wall to a length of either of the first retaining wall and the third retaining wall is in a range from 10% to 50%.

4. The compensation nut fastening assembly according to claim 1, wherein the first retaining wall, the second retaining wall and the third retaining wall are straight walls.

5. The compensation nut fastening assembly according to claim 4, wherein the first retaining wall, the second retaining wall and the third retaining wall are provided with guide flared openings on top portions thereof.

6. The compensation nut fastening assembly according to claim 1, wherein the torque clip is provided with hollowed portions penetrating through the torque clip in a thickness direction of the torque clip.

7. The compensation nut fastening assembly according to claim 6, wherein the hollowed portions comprise a first hollowed portion and a second hollowed portion, the first hollowed portion extending from the first connecting wall into the first retaining wall and the second retaining wall, and the second hollowed portion extending from the second connecting wall into the second retaining wall and the third retaining wall.

8. The compensation nut fastening assembly according to claim 1, wherein the torque clip is integrally made of metal.

9. A torque clip for a compensation nut fastening assembly, the torque clip comprising:
a first retaining wall,
a second retaining wall connected to the first retaining wall by a first connecting wall, the first connecting wall forming a pair of first bent protrusions with the first retaining wall and the second retaining wall; and
a third retaining wall connected to the second retaining wall by a second connecting wall and separated from the first retaining wall, the second connecting wall forming a pair of second bent protrusions with the second retaining wall and the third retaining wall, and the first retaining wall and the third retaining wall forming a first free end and a second free end, respectively,
wherein the first retaining wall, the second retaining wall, and the third retaining wall jointly form a fastener passage, and
wherein the torque clip has a substantially triangular cross section.

10. The torque clip according to claim 9, wherein a ratio of a length of either of the first connecting wall and the second connecting wall to a length of either of the first retaining wall and the third retaining wall is in a range from 10% to 50%.

11. The torque clip according to claim 9, wherein the first retaining wall, the second retaining wall and the third retaining wall are straight walls.

12. The torque clip according to claim 9, wherein the first retaining wall, the second retaining wall and the third retaining wall are provided with guide flared openings on top portions thereof.

13. The torque clip according to claim 9, wherein the torque clip is provided with hollowed portions penetrating through the torque clip in a thickness direction of the torque clip.

14. The torque clip according to claim 13, wherein the hollowed portions comprise a first hollowed portion and a second hollowed portion, the first hollowed portion extending from the first connecting wall into the first retaining wall and the second retaining wall, and the second hollowed portion extending from the second connecting wall into the second retaining wall and the third retaining wall.

15. The torque clip according to claim 9, wherein the torque clip is integrally made of metal.
